(19) United States
(12) Patent Application Publication
(10) Pub. No.: US 2026/0146146 A1
(43) Pub. Date: May 28, 2026

(54) EXTRUSION MOLDING MATERIAL AND BUILDING MATERIAL

(71) Applicant: YKK AP Inc., Tokyo (JP)

(72) Inventors: Masaki Wakabayashi, Tokyo (JP); Masahiro Yoshino, Tokyo (JP)

(21) Appl. No.: 19/346,605

(22) Filed: Oct. 1, 2025

(30) Foreign Application Priority Data
Nov. 25, 2024 (JP) 2024-204951

(51) Int. Cl. C08L 1/02; B29C 48/00; B29K 401/00; B29L 31/10

(52) U.S. Cl. CPC C08L 1/02; B29C 48/022; B29K 2401/00; B29L 2031/10

(57) ABSTRACT

An extrusion molding material includes: a base containing a cellulosic powder subjected to chemical treatment and a resin; and a surface layer containing a cellulosic powder subjected to chemical treatment and a resin and covering the base, a content rate of the cellulosic powder in the surface layer being lower than a content rate of the cellulosic powder in the base.

### CROSS-REFERENCE TO RELATED APPLICATION(S)

The present application claims priority to and incorporates by reference the entire contents of Japanese Patent Application No. 2024-204951 filed in Japan on November 25, 2024.

### BACKGROUND

### 1. TECHNICAL FIELD

The present disclosure relates to an extrusion molding material containing a cellulosic powder subjected to chemical treatment and a resin, and a building material including the extrusion molding material.

### 2. RELATED ART

In consideration of the environment, a cellulosic powder is sometimes blended in an extrusion molding material. The cellulosic powder is, for example, produced from a raw material derived from a plant, mixed with a resin, and contained in the extrusion molding material. Such an extrusion molding material is used for various building materials, and is required to have durability so as to withstand long-term use. Therefore, before mixing with the resin, the cellulosic powder may be subjected to chemical treatment for modifying durability. Conventionally, thermoplastic modified wood including wood powder subjected to acetylation or the like is known as the cellulosic powder (see JP S57-103804 A).

The conventional thermoplastic modified wood described in JP S57-103804 A is mixed with a thermoplastic resin and molded into a molded article. Introduction of at least one organic group into a part of a hydroxyl group of the thermoplastic modified wood leads to an improvement of the affinity of the thermoplastic modified wood for the thermoplastic resin, and uniform dispersion of the thermoplastic modified wood in the thermoplastic resin. However, a conventional molded article having an increased content rate of the thermoplastic modified wood may lead to noticeable discoloration of the surface of the molded article due to discoloration of the thermoplastic modified wood by sunlight (in particular, ultraviolet rays). Therefore, with consideration for the environment, it is difficult to meet the demand for increasing the content rate of the thermoplastic modified wood.

### SUMMARY

In some embodiments, an extrusion molding material includes: a base containing a cellulosic powder subjected to chemical treatment and a resin; and a surface layer containing a cellulosic powder subjected to chemical treatment and a resin and covering the base, a content rate of the cellulosic powder in the surface layer being lower than a content rate of the cellulosic powder in the base.

In some embodiments, a building material includes the extrusion molding material above.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a perspective view illustrating a deck including a building material of the present embodiment;

FIGS. 2A and 2B are drawings illustrating an extrusion molding material of the present embodiment;

FIG. 3 is a flowchart illustrating a procedure (steps) for manufacturing the extrusion molding material and the building material of the present embodiment;

FIGS. 4A to 4H are drawings schematically illustrating the state of each stage in the process of manufacturing the extrusion molding material of the present embodiment; and

FIGS. 5A and 5B are drawings illustrating another example of the extrusion molding material of the present embodiment.

### DETAILED DESCRIPTION

An embodiment of an extrusion molding material and a building material of the disclosure will be described with reference to the drawings.

The extrusion molding material of the present embodiment is a profile material obtained by extrusion molding, and is formed to have a constant cross-sectional shape over the entire longitudinal direction by an extruder. In addition, the building material of the present embodiment includes the extrusion molding material of the present embodiment, and is used as a material for construction. The building material is composed of an extrusion molding material, and the extrusion molding material and the building material are used, for example, for an outdoor structure that is required to have durability.

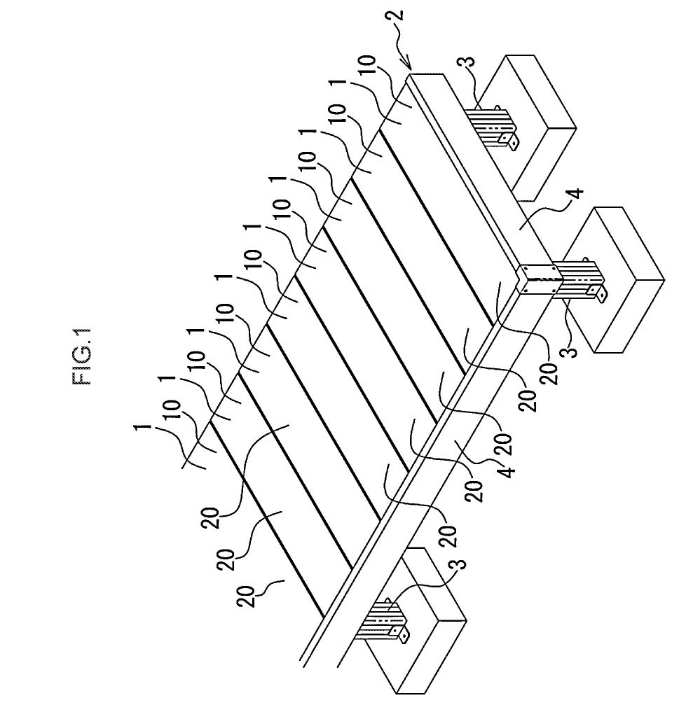

FIG. 1 is a perspective view illustrating a deck 2 including building materials 1 of the present embodiment, and illustrates a part of the deck 2 as viewed obliquely from above.

As illustrated in the drawing, the deck 2 is an outdoor structure, is attached to a building (not illustrated), and is installed outdoors. The deck 2 includes a plurality of bundle members 3, a plurality of lumber girders (not illustrated) bridged over the bundle members 3, a plurality of joists (not illustrated) bridged over the lumber girders, a plurality of floor members 10 laid on the plurality of joists, and a curtain plate 4 provided around the plurality of floor members 10.

The plurality of floor members 10 are plate-shaped deck members (plate members), and are provided on a floor surface of the deck 2. The plurality of floor members 10 are arranged in parallel with the edges being in contact with each other to form a floor surface of the deck 2. The floor members 10 are the building materials 1 used for the deck 2, and are provided on a part of the deck 2 to constitute a part of the deck 2. Each of the plurality of floor members 10 and the plurality of building materials 1 includes an extrusion molding material 20, and the floor members 10 and the building materials 1 are manufactured by processing the extrusion molding materials 20 having the same cross-sectional shape. The floor members 10, the building materials 1, and the extrusion molding materials 20 are installed outside the building and exposed to an outdoor environment.

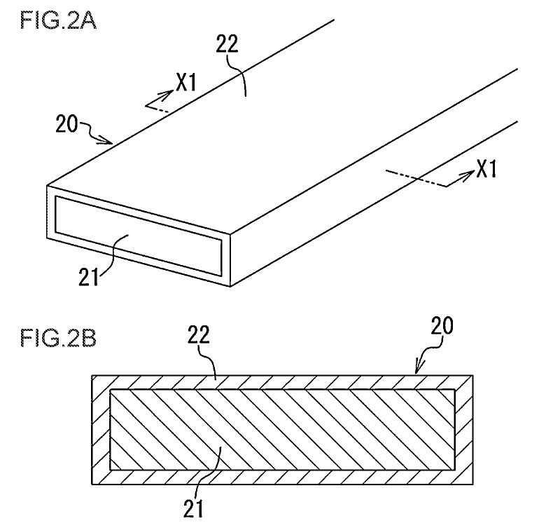

FIGS. 2A and 2B are drawings illustrating the extrusion molding material 20 of the present embodiment, and FIG. 2A is a perspective view illustrating a part of the extrusion molding material 20 in the longitudinal direction. FIG. 2B is a cross-sectional portion of the extrusion molding material 20 taken along line X1-X1 in FIG. 2A, and illustrates a cross section orthogonal to the longitudinal direction of the extrusion molding material 20.

As illustrated in the drawing, the extrusion molding material 20 includes a base 21 and a surface layer 22 that are integrally formed by extrusion molding. The base 21 is a central portion located on the center of the extrusion molding material 20, and constitutes a main portion of the extrusion molding material 20. The surface layer 22 is an outer surface portion located on the outer surface of the extrusion molding material 20, and is formed so as to overlap the outer surface of the base 21 to constitute the outer surface of the extrusion molding material 20.

The extrusion molding material 20 contains at least a cellulosic powder subjected to chemical treatment and a resin. The extrusion molding material 20 has two integral parts (the base 21 and the surface layer 22), and is formed in a solid structure (solid shape). The surface layer 22 is a covering portion covering the outer surface of the base 21, and covers the base 21. The base 21 is an inner portion located on an inner side of the extrusion molding material 20 with respect to the surface layer 22, and is covered with the surface layer 22 except for a portion of the base 21 located on an end surface of the extrusion molding material 20 in the longitudinal direction. The base 21 and the surface layer 22 are joined to each other to constitute the extrusion molding material 20.

The base 21 in the extrusion molding material 20 contains at least a cellulosic powder subjected to chemical treatment and a resin, and the surface layer 22 in the extrusion molding material 20 contains at least a cellulosic powder subjected to chemical treatment and a resin. The cellulosic powder is a pulverulent body (powder) containing cellulose as a main component, and contains other components in addition to cellulose. The cellulosic powder is produced from a raw material obtained from a plant containing cellulose, and is formed in powder form. The cellulosic powder includes, for example, at least one of wood powder, bamboo powder, pulp, wood fiber powder, rice hulls, or wastepaper powder.

The chemical treatment is modification treatment for chemically modifying (improving) the cellulosic powder, and the cellulosic powder is modified using a chemical agent. The chemical agent is a liquid or gas chemical (a modifier) that modifies the cellulosic powder. Here, the chemical treatment is modification treatment (durability treatment) for modifying the durability of the cellulosic powder. The cellulosic powder subjected to chemical treatment is a cellulosic powder having durability modified by chemical treatment, and has higher durability than the durability of a cellulosic powder not subjected to chemical treatment. Examples of the durability of the cellulosic powder include decay resistance, weather resistance, termite resistance, strength, and water resistance. In the cellulosic powder subjected to chemical treatment, absorption of moisture into the cellulosic powder is reduced.

Examples of the chemical treatment of the cellulosic powder include acetylation treatment, formalization treatment, phenol resin treatment, acrylic resin treatment, and furan resin treatment. Therefore, examples of the cellulosic powder subjected to chemical treatment include an acetylation-treated cellulosic powder subjected to acetylation treatment and acetylated (an acetylated cellulosic powder), a formalization-treated cellulosic powder subjected to formalization treatment and formalized (a formalized cellulosic powder), a phenol resin-treated cellulosic powder subjected to phenol resin treatment and impregnated with a phenol resin, an acrylic resin-treated cellulosic powder subjected to acrylic resin treatment and impregnated with an acrylic resin, and a furan resin-treated cellulosic powder subjected to furan resin treatment and impregnated with a furan resin.

The resin contained in the base 21 and the surface layer 22 in the extrusion molding material 20 is a synthetic resin, and is mixed with the cellulosic powder subjected to chemical treatment. The base 21 and the surface layer 22 contain a compatibilizer that increases the affinity between the cellulosic powder subjected to chemical treatment and the resin. The compatibilizer is an additive that assists mixing of the cellulosic powder subjected to chemical treatment and the resin, and has high affinity for each of the cellulosic powder subjected to chemical treatment and the resin. The compatibilizer enhances the compatibility between the cellulosic powder subjected to chemical treatment and the resin, resulting in uniform mixing of the cellulosic powder subjected to chemical treatment and the resin. Here, the resin includes a thermoplastic resin, and includes polypropylene, polyethylene, or polyvinyl chloride. The compatibilizer includes an unsaturated carboxylic acid-modified polyolefin.

The base 21 and the surface layer 22 in the extrusion molding material 20 contain raw materials including the cellulosic powder subjected to chemical treatment and the resin. The raw materials constitute each of the base 21 and the surface layer 22 in a state of being mixed with each other, and the cellulosic powder is dispersed in each of the base 21 and the surface layer 22. The base 21 and the surface layer 22 contain other additives in addition to the compatibilizer.

Examples of other additives include at least one of a colorant, an antioxidant, an ultraviolet absorber, a light stabilizer, an antistatic agent, a lubricant, and a filler, and each of the base 21 and the surface layer 22 contains at least one additive among a plurality of other additives.

The base 21 and the surface layer 22 in the extrusion molding material 20 have different content rates of the cellulosic powder subjected to chemical treatment and the resin. The surface layer 22 has a content rate of the cellulosic powder lower (smaller) than the content rate of the cellulosic powder in the base 21, and the surface layer 22 has a content rate of the resin higher (larger) than the content rate of the resin in the base 21. Therefore, the base 21 has a content rate of the cellulosic powder higher (larger) than the content rate of the cellulosic powder in the surface layer 22, and the base 21 has a content rate of the resin lower (smaller) than the content rate of the resin in the surface layer 22.

The content is represented by mass percent (mass% (wt%)), and is calculated for each of the base 21 and the surface layer 22 based on the total mass of the base 21 and the surface layer 22. The content rate of each component (the cellulosic powder subjected to chemical treatment, the resin, the compatibilizer, and the like) contained in each of the base 21 and the surface layer 22 is represented by mass%. The content rate of the cellulosic powder in the base 21 is represented by percentage by mass (mass%) of the cellulosic powder based on the total mass of the base 21, and the content rate of the resin in the base 21 is represented by percentage by mass (mass%) of the resin based on the total mass of the base 21. The content rate of the cellulosic powder in the surface layer 22 is represented by percentage by mass (mass%) of the cellulosic powder based on the total mass of the surface layer 22, and the content rate of the resin in the surface layer 22 is represented by percentage by mass (mass%) of the resin based on the total mass of the surface layer 22.

The base 21 in the extrusion molding material 20 has a content rate of the cellulosic powder of 45 to 90 mass% (45 mass% or more and 90 mass% or less). The cellulosic powder is blended in the base 21 so that the base 21 has a content rate of the cellulosic powder within a range of 45 to 90 mass%, and the content rate of the cellulosic powder in the base 21 is adjusted within a range of 45 to 90 mass%. The surface layer 22 in the extrusion molding material 20 has a content rate of the cellulosic powder of 1 to 40 mass% (1 mass% or more and 40 mass% or less). The cellulosic powder is blended in the surface layer 22 so that the surface layer 22 has a content rate of the cellulosic powder within a range of 1 to 40 mass%, and the content rate of the cellulosic powder in the surface layer 22 is adjusted within a range of 1 to 40 mass%.

Each of the base 21 and the surface layer 22 in the extrusion molding material 20 contains the compatibilizer in an amount of 0.5 to 5 wt% (0.5 wt% or more and 5 wt% or less). The compatibilizer is blended in each of the base 21 and the surface layer 22 so that each of the base 21 and the surface layer 22 has a content rate of the compatibilizer within a range of 0.5 to 5 wt%, and the content rate of the compatibilizer in each of the base 21 and the surface layer 22 is adjusted within a range of 0.5 to 5 wt%. In each of the base 21 and the surface layer 22, the resin is contained at the highest content among the components of the base 21 and the surface layer 22 excluding the cellulosic powder and the compatibilizer, and an additive other than the compatibilizer is further added to the base 21 and the surface layer 22.

The surface layer 22 in the extrusion molding material 20 has a thickness of 0.5 to 5 mm (0.5 mm or more and 5 mm or less). The surface layer 22 is entirely formed to have a thickness within a range of 0.5 to 5 mm, and is exposed to the outside of the extrusion molding material 20. The base 21 is shielded by the surface layer 22 except for a portion located at the end surface of the extrusion molding material 20 in the longitudinal direction, and is not exposed to the outside of the extrusion molding material 20.

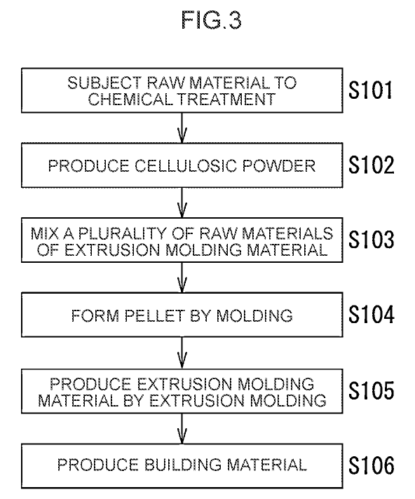

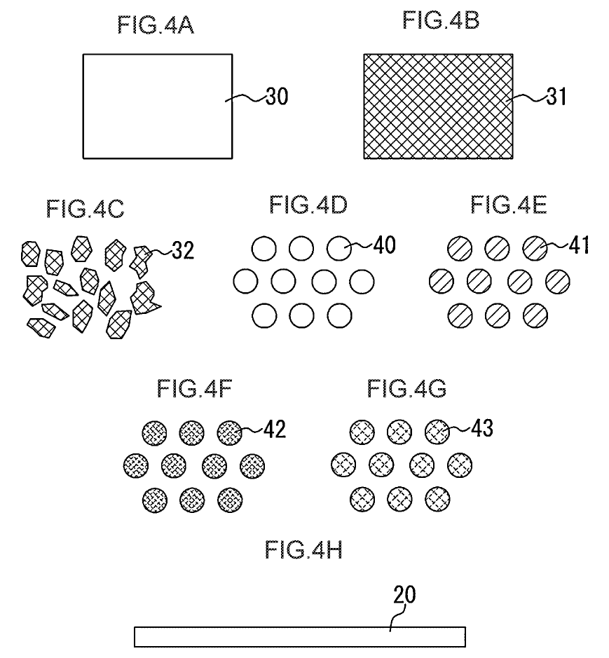

FIG. 3 is a flowchart illustrating a procedure (steps) for manufacturing the extrusion molding material 20 and the building materials 1 of the present embodiment. FIGS. 4A to 4H are drawings schematically illustrating the state of each stage in the process of manufacturing the extrusion molding material 20 of the present embodiment.

As illustrated in the flowchart, a raw material is chemically treated (S101 in FIG. 3) before manufacturing the extrusion molding material 20 (before extrusion molding) to produce a cellulosic powder subjected to chemical treatment (S102 in FIG. 3). The raw material is a material serving as a base of the cellulosic powder subjected to chemical treatment, and includes either a cellulosic powder not subjected to chemical treatment or a non-powder 30 serving as a base of the cellulosic powder not subjected to chemical treatment (see FIG. 4A).

The non-powder 30 as a raw material is chemically treated to obtain a non-powder 31 subjected to chemical treatment (a chemically treated non-powder) (see FIG. 4B). Subsequently, the non-powder is formed in powder form to produce a cellulosic powder 32 subjected to chemical treatment (a chemically treated cellulosic powder) (see FIG. 4C). Here, the non-powder 30 is wood, and the cellulosic powder 32 is wood powder subjected to chemical treatment (chemically treated wood powder).

The non-powder 31 that is wood subjected to chemical treatment (chemically treated wood) or an end material of the non-powder 31 is pulverized to produce the wood powder. Alternatively, the non-powder 31 is processed (including cutting the non-powder 31) to produce the wood powder such as sawdust and chips. Meanwhile, the cellulosic powder not subjected to chemical treatment as a raw material is chemically treated to produce the cellulosic powder 32 subjected to chemical treatment.

Next, a plurality of raw materials of the extrusion molding material 20 are mixed (S103 in FIG. 3), and a pellet containing the plurality of raw materials is formed by molding (S104 in FIG. 3). The plurality of raw materials include the cellulosic powder 32 subjected to chemical treatment, a resin, a compatibilizer, and other additives. Here, the resin is a granular pellet (a resin pellet 40, see FIG. 4D), and the compatibilizer is a granular pellet (a compatibilizer pellet 41, see FIG. 4E). The resin in the resin pellet 40 includes a virgin resin, a recycled resin, or a biomass resin.

The plurality of raw materials including the cellulosic powder 32, the resin (the resin pellet 40), and the compatibilizer (the compatibilizer pellet 41) are charged into an extruder, kneaded while being heated in the extruder, and mixed with each other. The mixture of several raw materials that have been mixed is cut while being extruded by the extruder, and the mixture is molded into granular raw material pellets 42 and 43 (see FIG. 4F and FIG. 4G). The raw material pellets 42 and 43 are pellets serving as a raw material of the extrusion molding material 20 when the extrusion molding material 20 is obtained by extrusion molding.

The two raw material pellets 42 and 43 (the first raw material pellet 42 and the second raw material pellet 43) are separately molded by an extruder. Of the two raw material pellets 42 and 43, the first raw material pellet 42 serves as a raw material for the base 21 in the extrusion molding material 20, while the second raw material pellet 43 serves as a raw material for the surface layer 22 in the extrusion molding material 20. The two raw material pellets 42 and 43 have different content rates of the cellulosic powder 32 subjected to chemical treatment and of the resin.

The two raw material pellets 42 and 43 are heated and melted by an extruder capable of co-extrusion, and co-extruded into the base 21 and the surface layer 22 by continuous extrusion molding. As a result, the base 21 is formed by extrusion molding using the first raw material pellet 42 as a raw material, while the surface layer 22 is formed by extrusion molding using the second raw material pellet 43 as a raw material. In this manner, the extrusion molding material 20 in which the base 21 and the surface layer 22 are integrated (see FIG. 4H) is continuously manufactured by extrusion molding (S105 in FIG. 3). The extrusion molding material 20 is cut in a direction intersecting the longitudinal direction. Thereafter, the extrusion molding material 20 is processed to manufacture the building material 1 from the extrusion molding material 20 (S106 in FIG. 3).

In the extrusion molding material 20 described above, the surface layer 22 has a content rate of the cellulosic powder 32 that is lower than the content rate of the cellulosic powder 32 in the base 21. Therefore, when the cellulosic powder 32 in the surface layer 22 in the extrusion molding material 20 is discolored by sunlight (in particular, ultraviolet rays), the degree of discoloration of the surface layer 22 can be lowered to make the discoloration of the surface layer 22 less noticeable. The base 21 has a content rate of the cellulosic powder 32 higher than the content rate of the cellulosic powder 32 in the surface layer 22, and the content (addition amount) of the cellulosic powder 32 in the base 21 in the extrusion molding material 20 can be increased. Therefore, in the extrusion molding material 20 and the building material 1, the amount of the cellulosic powder 32 contained in the extrusion molding material 20 can be increased while preventing the discoloration of the surface of the extrusion molding material 20.

The surface layer 22 in the extrusion molding material 20 having a content rate of the cellulosic powder 32 of less than 1 mass% hardly provides wood texture by the cellulosic powder 32. The surface layer 22 in the extrusion molding material 20 having a content rate of the cellulosic powder 32 of more than 40 mass% leads to noticeable discoloration of the surface layer 22 due to discoloration of the cellulosic powder 32. Meanwhile, the surface layer 22 in the extrusion molding material 20 having a content rate of the cellulosic powder 32 of 1 to 40 mass% can ensure the wood texture of the surface layer 22, and can prevent the noticeable discoloration of the surface layer 22. The surface layer 22 in the extrusion molding material 20 more preferably has a content rate of the cellulosic powder 32 of 15 to 35 mass% (15 mass% or more and 35 mass% or less). The surface layer 22 in the extrusion molding material 20 having a content rate of the cellulosic powder 32 of 15 to 35 mass% can make the discoloration of the surface layer 22 less noticeable while enhancing the wood texture of the surface layer 22.

The base 21 in the extrusion molding material 20 having a content rate of the cellulosic powder 32 of less than 45 mass% may lead to a decrease in the amount of the cellulosic powder 32 contained in the base 21. The base 21 in the extrusion molding material 20 having a content rate of the cellulosic powder 32 of more than 90 mass% may make the extrusion molding of the base 21 in the extrusion molding material 20 difficult due to the influence of the cellulosic powder 32. Meanwhile, the base 21 in the extrusion molding material 20 having a content rate of the cellulosic powder 32 of 40 to 90 mass% can ensure an adequate amount of the cellulosic powder 32 contained in the base 21, and can result in formation of the base 21 by smooth extrusion molding. The base 21 more preferably has a content rate of the cellulosic powder 32 of 45 to 65 mass% (45 mass% or more and 65 mass% or less). The base 21 having a content rate of the cellulosic powder 32 of 45 to 65 mass% can ensure an adequate content rate of the cellulosic powder 32 contained in the base 21, and can result in formation of the base 21 by easy extrusion molding.

The surface layer 22 in the extrusion molding material 20 having a thickness of less than 0.5 mm may affect the impact strength of the surface layer 22. When the surface layer 22 is scratched, the base 21 may be exposed. The surface layer 22 having a thickness of more than 5 mm may lead to an increase in the cost of the extrusion molding material 20 due to an increase in the amount of the resin contained in the surface layer 22. Meanwhile, the surface layer 22 having a thickness of 0.5 to 5 mm can ensure the impact strength of the surface layer 22, and can prevent an increase in the amount of the resin contained in the surface layer 22 and an increase in the cost of the extrusion molding material 20. The surface layer 22 more preferably has a thickness of 1 to 2 mm (1 mm or more and 2 mm or less). The surface layer 22 having a thickness of 1 to 2 mm can ensure the impact strength of the surface layer 22, and can surely prevent an increase in the amount of the resin contained in the surface layer 22 and an increase in the cost of the extrusion molding material 20.

As for the resin and the compatibilizer contained in the base 21 and the surface layer 22 in the extrusion molding material 20, polypropylene and the unsaturated carboxylic acid-modified polyolefin have high compatibility and have good affinity. Therefore, the base 21 and the surface layer 22 in the extrusion molding material 20 containing polypropylene as the resin and the unsaturated carboxylic acid-modified polyolefin as the compatibilizer enhance the impact strength of the base 21, the surface layer 22, and the extrusion molding material 20. The surface layer 22 with a colorant being added for design, decoration, and the like reflects sunlight including ultraviolet rays, and prevents sunlight from reaching the base 21. As a result, the surface layer 22 with the colorant prevents the discoloration of the cellulosic powder 32 contained in the base 21 due to sunlight.

The cellulosic powder 32 subjected to chemical treatment hardly absorbs moisture. Therefore, when the extrusion molding material 20 is used in a place where the extrusion molding material 20 is in a wet state (for example, a place in direct contact with water such as in the ground, in water, or in a puddle, or a place with high temperature and high humidity), absorption of water into the extrusion molding material 20 and a change in dimension of the extrusion molding material 20 are prevented. The extrusion molding material 20 can be used not only for the building material 1 of the deck 2, but also for the building material 1 of various structures (for example, an exterior such as a fence or a louver, or a building). The extrusion molding material 20 can be formed not only in a solid structure (solid shape), but also in various structures (shapes).

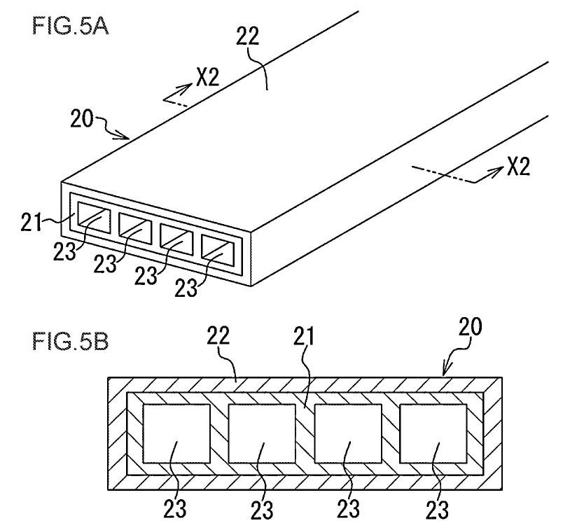

FIGS. 5A and 5B are drawings illustrating another example of the extrusion molding material 20 of the present embodiment, and FIG. 5A is a perspective view illustrating a part of the extrusion molding material 20 in the longitudinal direction. FIG. 5B illustrates a cross-sectional portion of the extrusion molding material 20 taken along line X2-X2 in FIG. 5A, and illustrates a cross section orthogonal to the longitudinal direction of the extrusion molding material 20.

As illustrated in the drawing, the extrusion molding material 20 includes at least one hollow portion 23 and is formed in a hollow structure (hollow shape). The hollow portion 23 is formed in a hollow shape inside the extrusion molding material 20 and extends in the longitudinal direction of the extrusion molding material 20. Here, a plurality of hollow portions 23 are formed inside the base 21 in the extrusion molding material 20. The plurality of hollow portions 23 are formed in parallel while spaced apart from each other.

As described above, the present embodiment discloses the extrusion molding material described in the following (1) to (3) and the building material described in the following (4).

(1) An extrusion molding material includes:

a base containing a cellulosic powder subjected to chemical treatment and a resin; and

a surface layer containing a cellulosic powder subjected to chemical treatment and a resin and covering the base, a content rate of the cellulosic powder in the surface layer being lower than a content rate of the cellulosic powder in the base.

In the extrusion molding material described in (1), the amount of the cellulosic powder contained in the extrusion molding material can be increased while preventing discoloration of a surface of the extrusion molding material containing the cellulosic powder subjected to chemical treatment and the resin.

(2) In the extrusion molding material according to (1), the content rate of the cellulosic powder in the surface layer is 1 to 40 mass%, and the content rate of the cellulosic powder in the base is 45 to 90 mass%.

The extrusion molding material described in (2) can ensure wood texture of a surface layer, and can prevent noticeable discoloration of the surface layer. The extrusion molding material described in (2) can ensure an adequate amount of the cellulosic powder contained in the base, and can result in formation of the base by smooth extrusion molding.

(3) In the extrusion molding material according to (1) or (2), the surface layer has a thickness of 0.5 to 5 mm.

The extrusion molding material described in (3) can ensure the impact strength of the surface layer, and can prevent an increase in the amount of the resin contained in the surface layer and an increase in the cost of the extrusion molding material.

(4) A building material includes the extrusion molding material according to any one of (1) to (3).

In the building material described in (4), the amount of the cellulosic powder contained in the extrusion molding material can be increased while preventing discoloration of a surface of the extrusion molding material containing the cellulosic powder subjected to chemical treatment and the resin.

According to the disclosure, the amount of a cellulosic powder contained in an extrusion molding material can be increased while preventing the discoloration of a surface of the extrusion molding material containing the cellulosic powder subjected to chemical treatment and the resin.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An extrusion molding material comprising:
a base containing a cellulosic powder subjected to chemical treatment and a resin; and
a surface layer containing a cellulosic powder subjected to chemical treatment and a resin and covering the base, a content rate of the cellulosic powder in the surface layer being lower than a content rate of the cellulosic powder in the base.

2. The extrusion molding material according to claim 1, wherein
the content rate of the cellulosic powder in the surface layer is 1 to 40 mass%, and
the content rate of the cellulosic powder in the base is 45 to 90 mass%.

3. The extrusion molding material according to claim 1, wherein
the surface layer has a thickness of 0.5 to 5 mm.

4. A building material comprising the extrusion molding material according to claim 1.
